(19) United States
(12) Patent Application Publication
(10) Pub. No.: US 2026/0229814 A1
(43) Pub. Date: Aug. 6, 2026

(54) SEAL PORTION STRUCTURE FOR CONNECTOR

(71) Applicants: TOYOTA JIDOSHA KABUSHIKI KAISHA, Toyota-shi (JP); Sumitomo Wiring Systems, Ltd., Yokkaichi (JP)

(72) Inventors: Masahiro OGAWA, Nagoya-shi (JP); Keishi KITAMURA, Yokkaichi-shi (JP); Masato KAMEMURA, Yokkaichi-shi (JP); Asuka KOBAYASHI, Yokkaichi-shi (JP)

(73) Assignees: TOYOTA JIDOSHA KABUSHIKI KAISHA, Toyota-shi (JP); Sumitomo Wiring Systems, Ltd., Yokkaichi (JP)

(21) Appl. No.: 19/453,239

(22) Filed: Jan. 20, 2026

(30) Foreign Application Priority Data
Jan. 23, 2025 (JP) 2025-010086

(51) Int. Cl. H01R 13/52; H01R 13/6581

(52) U.S. Cl. CPC H01R 13/5219; H01R 13/5216; H01R 13/6581

(57) ABSTRACT

A seal portion structure on fitting surfaces of a male shield shell and a female shield shell that constitute a connector includes: a first rib provided on an end portion of the female shield shell and protruding in a direction toward the male shield shell; and a rubber gasket provided between the fitting surfaces of the male shield shell and the female shield shell, wherein a gap is eliminated by the rubber gasket being squashed with the first rib to seal the fitting surfaces.

### CROSS-REFERENCE TO RELATED APPLICATION

This application claims priority to Japanese Patent Application No. 2025-010086 filed on January 23, 2025. The disclosure of the above-identified application, including the specification, drawings, and claims, is incorporated by reference herein in its entirety.

### BACKGROUND

### 1. Technical Field

The present disclosure relates to a structure in a seal portion of a connector.

### 2. Description of Related Art

Japanese Unexamined Patent Application Publication No. 2013-140821 (JP 2013-140821 A) discloses a connector having a structure in which a gap between a first shield shell and a second shield shell is sealed with a rubber gasket (rubber ring).

### SUMMARY

In general, in view of workability in fitting of a connector, a gap remains between fitting surfaces of a male shield shell and a female shield shell after the fitting. In order to seal this gap, there is normally used a gasket formed of a rubber material, or the like.

However, a structure, as illustrated in FIG. 4, in which a rubber gasket 700 is simply inserted between parts of fitting surfaces of a male shield shell 500 and a female shield shell 600 results in a concern that splashing water comes through an opening D and causes crevice corrosion between the male shield shell 500 and the female shield shell 600 to occur or that the rubber gasket 700 is directly splashed with water.

The present disclosure is devised in view of the aforementioned problem, and an object thereof is to provide a seal portion structure for a connector, the structure being able to restrain crevice corrosion between shield shells and to prevent a rubber gasket from being directly splashed with water.

In order to solve the aforementioned problem, an aspect of the presently disclosed technology relates to a seal portion structure for a connector, the seal portion structure being on fitting surfaces of a male shield shell and a female shield shell that constitute a connector, the seal portion structure including a first rib and a rubber gasket. The first rib is provided on an end portion of the female shield shell and protrudes in a direction toward the male shield shell. The rubber gasket is provided between the fitting surfaces of the male shield shell and the female shield shell. A gap is eliminated by the rubber gasket being squashed with the first rib to seal the fitting surfaces.

According to the seal portion structure for a connector of the present disclosure, restraining crevice corrosion between shield shells and preventing a rubber gasket from being directly splashed with water can be made compatible with each other.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a connector for which a seal portion structure according to an embodiment of the present disclosure is employed;

FIG. 2 is a sectional view taken along the A-A line in FIG. 1;

FIG. 3 is an expanded view of the portion B in FIG. 2; and

FIG. 4 is an expanded view of a place in a conventional structure example, the place corresponding to the portion B in FIG. 2.

### DETAILED DESCRIPTION OF EMBODIMENTS

### Embodiments

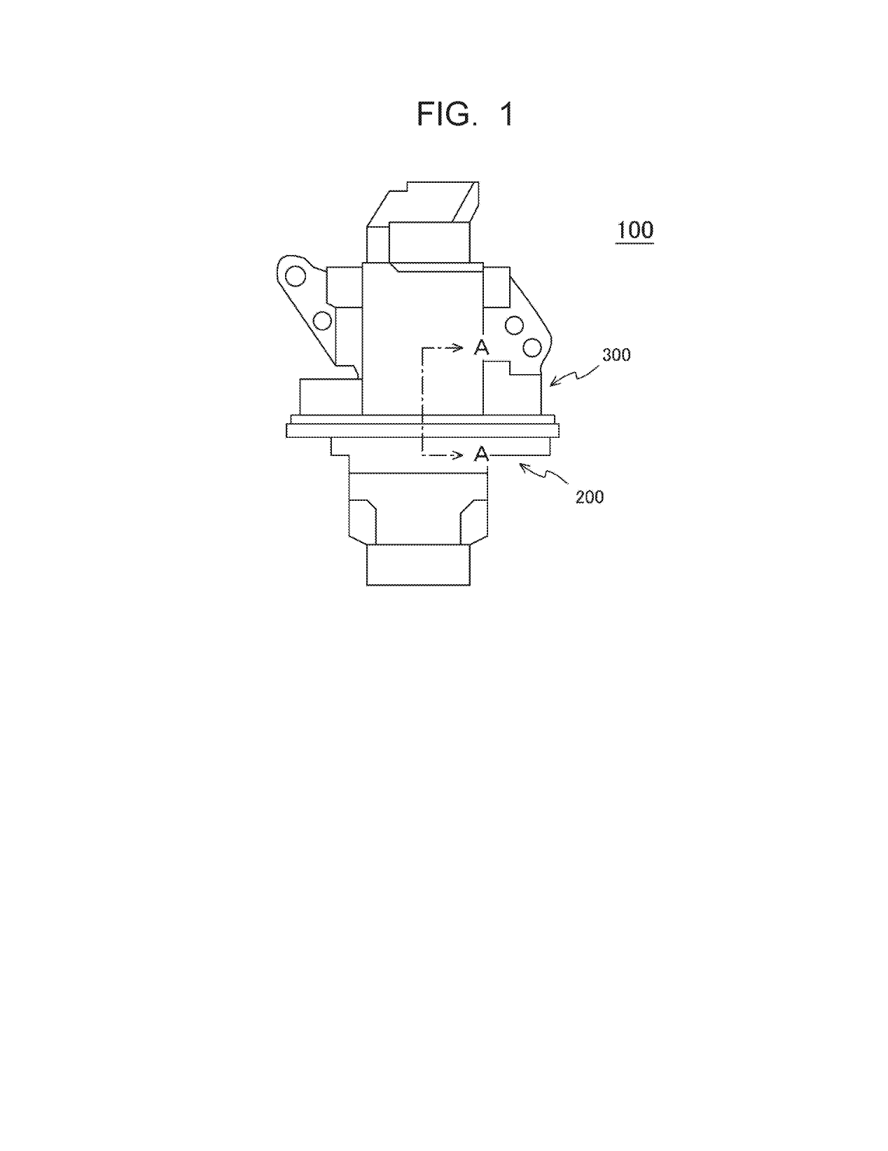

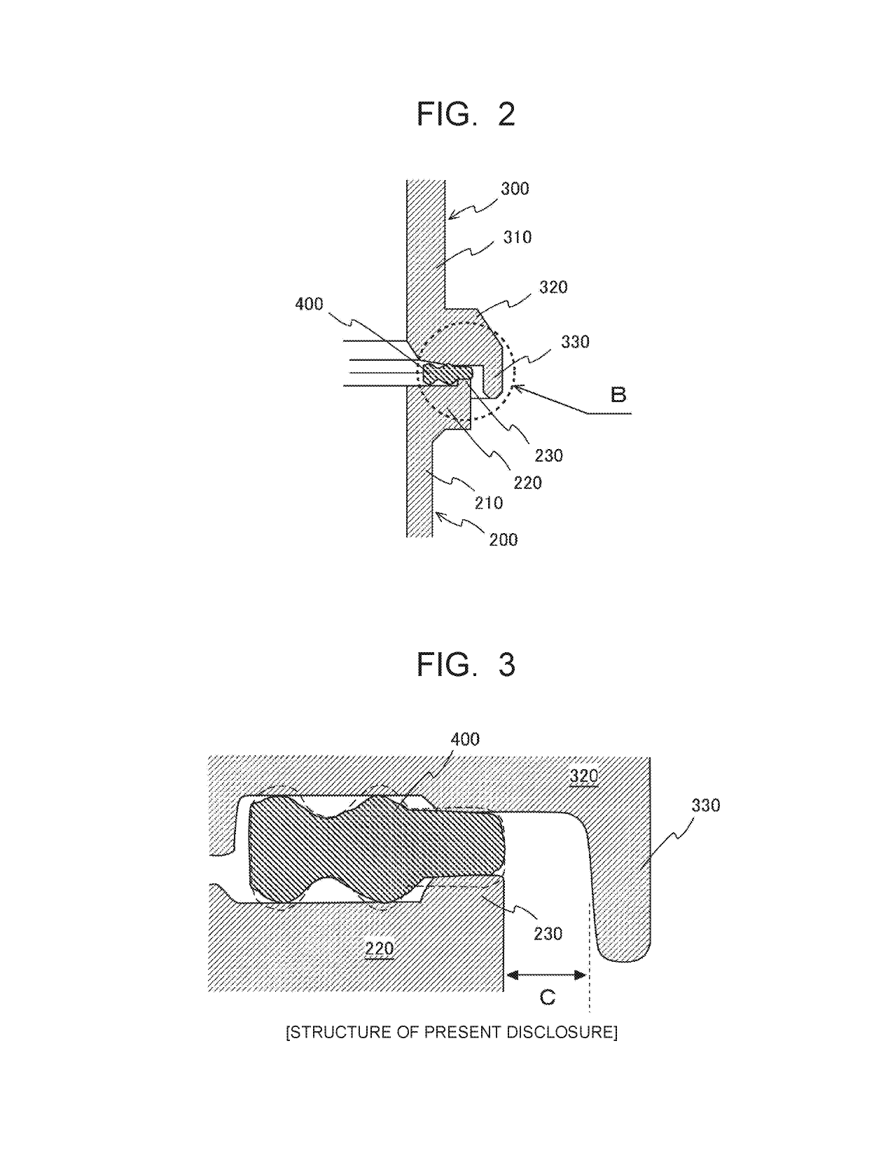

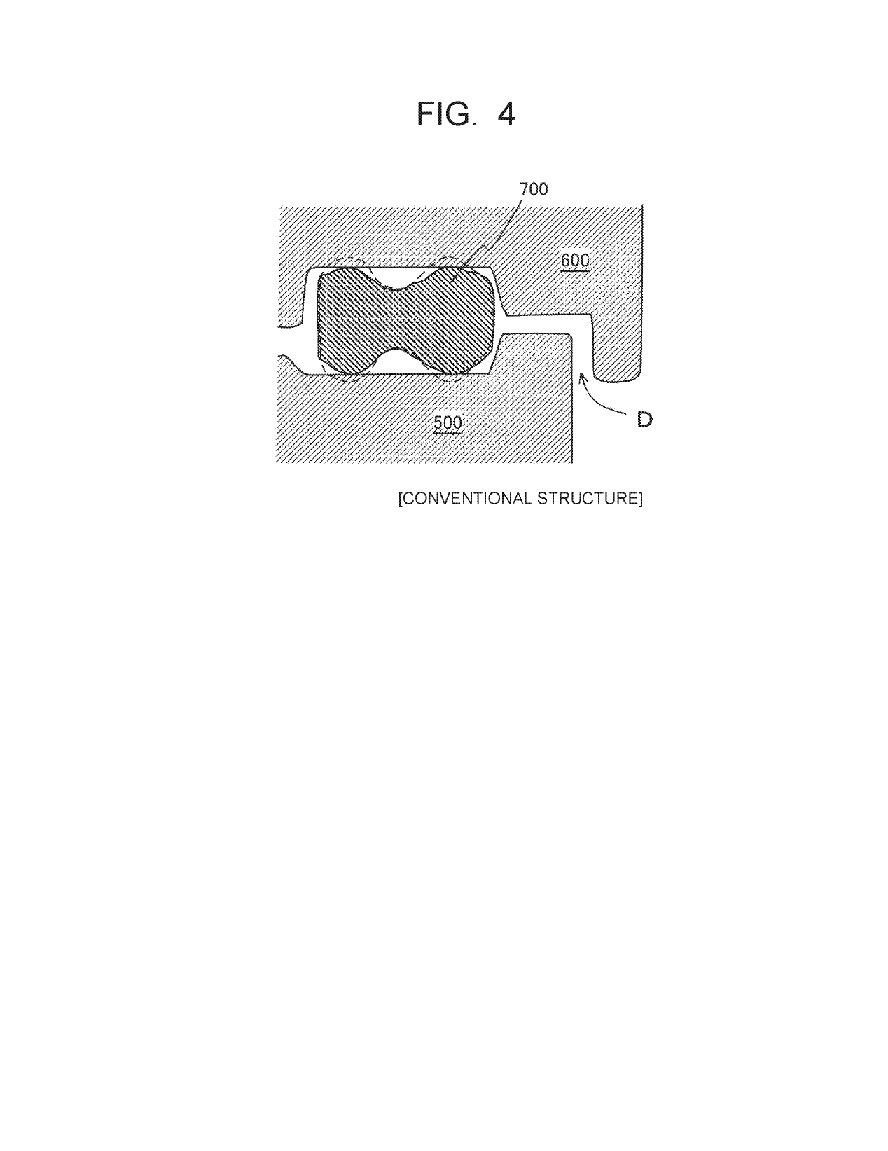

Hereafter, embodiments of the present disclosure will be described in detail with reference to the drawings. FIG. 1 is an appearance view for schematically explaining a configuration of a connector 100 for which a seal portion structure according to an embodiment of the present disclosure is employed. FIG. 2 is a view showing a section taken along the A-A line for the connector 100 illustrated in FIG. 1. The connector 100 illustrated in FIG. 1 and FIG. 2 includes a female shield shell 200, a male shield shell 300, and a rubber gasket 400.

The female shield shell 200 is a female-type component formed of a material having a shield function, and has a configuration including a body portion 210, a flange portion 220, and a rib portion 230 (hereinafter referred to as "first rib 230").

The body portion 210 is a substantially tubular structural portion that can be fitted into the inside of a fitting space included in a body portion 310 of the male shield shell 300 mentioned later. The flange portion 220 is provided at a predetermined position that defines a depth of fitting of the body portion 210, and is a substantially flat plate-shaped structural portion extending outward over the whole circumference of the body portion 210. The first rib 230 is a strong pressure rib-shaped structural portion that is provided on an outer end portion of the flange portion 220 and protrudes in a direction toward the male shield shell 300. The first rib 230 has a role of filling a gap by squashing a part of the rubber gasket 400 which is inserted between fitting surfaces of the female shield shell 200 and the male shield shell 300, when both shield shells are fitted to each other.

The male shield shell 300 is a male-type component formed of a material having a shield function, and has a configuration including the body portion 310, a flange portion 320, and a rib portion 330 (hereinafter referred to as "second rib 330").

The body portion 310 is a substantially tubular structural portion that has the fitting space inside that the body portion 210 of the female shield shell 200 can be fitted into. The flange portion 320 is provided at a predetermined position at which the flange portion 220 of the female shield shell 200 abuts on this flange portion 320, and is a substantially flat plate-shaped structural portion extending outward over the whole circumference of the body portion 310. The second rib 330 is an eave-shaped structural portion that is provided on an outer end portion of the flange portion 320 and protrudes in a direction toward the female shield shell 200.

Since this second rib 330 of the male shield shell 300 has the eave shape, the rubber gasket 400 is not exposed, and the rubber gasket 400 can be prevented from being directly splashed with water from the outside. Moreover, as shown in FIG. 3, the second rib 330 of the male shield shell 300 is provided at a position spaced by a predetermined distance C from the first rib 230 of the female shield shell 200 (end portion of the flange portion 220). The distance C is a dimension that scarcely causes crevice corrosion at the clearance between

the male shield shell 300 and the female shield shell 200, and is set to an appropriate value based on the materials of the shield shells, the environment of use of the connector 100, and the like. For example, since it is known that crevice corrosion is promoted at a narrow gap in which the clearance is not more than 0.2 mm, the distance C is desirably set to be wider than 0.2 mm.

The rubber gasket 400 is a component formed of an elastic rubber material, and has a function of sealing a gap by being inserted between the fitting surfaces of the female shield shell 200 and the male shield shell 300. As shown in FIG. 3, the rubber gasket 400 has a shape that is deformed by being interposed between the flange portion 220 of the female shield shell 200 and the flange portion 320 of the male shield shell 300, having the shape a part (end portion) of which is squashed by the first rib 230 of the female shield shell 200 and the flange portion 320 of the male shield shell 300 until the rubber gasket 400 is brought into close contact with the first rib 230 and the flange portion 320 without a gap. FIG. 3 shows, as to the rubber gasket 400, the shape before the deformation by the dotted line and the shape after the deformation due to the fitting of the shield shells by the solid line.

### Operation and Effects

As mentioned above, according to the seal portion structure for the connector 100 according to an embodiment of the present disclosure, in this structure that stops water by the rubber gasket 400 inserted into the gap between the male shield shell 300 and the female shield shell 200, a gap is eliminated by the rubber gasket 400 being squashed with the first rib 230 (strong pressure rib) provided at the end portion of the female shield shell 200, and the eave-shaped second rib 330 is included at a position of the male shield shell 300, the position being spaced by the predetermined distance C from the end portion of the female shield shell 200.

With this structure, the rubber gasket 400 can be prevented from being directly splashed with water, in order to stop water coming between the male shield shell 300 and the female shield shell 200, and crevice corrosion between the male and female shield shells (the rubber gasket and the end portions of the shield shells) can be restrained from occurring.

The seal portion structure of the present disclosure can be used for a high pressure connector to stop water coming between shield shells, and the like.

What is claimed is:

1. A seal portion structure for a connector, the seal portion structure being on fitting surfaces of a male shield shell and a female shield shell that constitute a connector, the seal portion structure comprising:
a first rib provided on an end portion of the female shield shell and protruding in a direction toward the male shield shell; and
a rubber gasket provided between the fitting surfaces of the male shield shell and the female shield shell, wherein
a gap is eliminated by the rubber gasket being squashed with the first rib to seal the fitting surfaces.

2. The seal portion structure according to claim 1, further comprising a second rib provided to protrude in a direction toward the female shield shell at a position of the male shield shell, the position being spaced by a predetermined distance from the end portion of the female shield shell.
